(19) United States
(12) Patent Application Publication
(10) Pub. No.: US 2004/0057341 A1
(43) Pub. Date: Mar. 25, 2004

(54) Carry-on chronometric device having UV detection and warning functions

(76) Inventor: Yuan Sung Weng, Taipei (TW)

Correspondence Address: BUCKNAM AND ARCHER, 1077 Northern Boulevard, Roslyn, NY, 11576-1696, US

(21) Appl. No.: 10/465,712

(22) Filed: Jun. 19, 2003

(30) Foreign Application Priority Data
Sep. 25, 2002 (TW) 091215162

(51) Int. Cl. G04B 47/06

(52) U.S. Cl. 368/11

(57) ABSTRACT

The invention provides a carry-on chronometric device having UV detection and warning functions, comprising a housing for defining a containing space which contains a control circuit, a display unit, a memory unit, and an input unit, a chronometric unit, a battery, and an UV detector unit and a time-varying intensity accumulator whereby the ambient UV intensity and its accumulating intensity can be detected and displayed at any time and any place for reference so as to achieve an efficacy of warning.

### BACKGROUND

1. Field of the Invention

The invention relates to a carry-on chronometric device having UV detection and warning functions and, more specifically, to a carry-on chronometric device, which is suitable for detection of UV intensity and display of chronometric time and date, capable of detecting and displaying ambient UV intensity and its accumulated dose.

2. Related Art of the Invention

Recently, due to destruction of ozone layer of the earth being increasingly serious, the exposure of UV ray is caused to be increased which becomes harmful to the health of the human body, such as harm of exposure, aging of skin and wrinkles, skin cancer, cataract and other ophthalmic disease, and destruction of the immunity system.

Normally, the people can only obtain the information from the weather report for the daily ultra-violet (UV) index in rough for reference, and is hard to be given accurately an ambient UV intensity at any time of a day, such that the harm of excess UV ray can not be effectively prevented and protected.

Therefore, it is necessary to exploit a convenient carry-on device which has a detection function for UV ray and is light, thin, short, small in volume together with the miniaturized size and inexpensive price. The device is also capable of wearing on in a long time without being taken off, so as to allow the user to be advantageous to detect the ambient UV intensity at any time and any place and obtain the efficacies of wearing and protection.

### SUMMARY OF THE INVENTION

In view of the above problems, the object of the invention is to provide a carry-on chronometric device having UV detection and warning functions, which can inform an user an ambient UV intensity and calculate an accumulated UV dose through built-in circuit units and time data of a chronometric unit in the device, so as to achieve an efficacy of warning the people as well as to have a function of carry-on chronometric device such as watch, and is capable of being an effective tool to prevent the people from injury of the UV ray.

In order to achieve the above object, according to one aspect of the invention, a carry-on chronometric device having UV detection and warning function is provided for detection of UV ray and display of time and data. The device comprises a housing for defining a containing space, which contains a control circuit unit for processing the time and data and controlling action of each member of the device based on a control signal, a display unit for displaying the time and data, a memory unit for storing the data, an input unit for input of the control signal to the control circuit unit to allow the control circuit unit to process the data and control the action of each member of the device based on the control signal, a chronometric unit for providing the time, a battery for providing a working voltage to each member, an UV detector unit for detecting an intensity of the UV ray, and a time-varying intensity accumulator for accumulating the intensity of the UV ray and calculating an accumulated dose of the intensity and for output of the intensity and the accumulated dose to the display unit for displaying and to the memory unit for storage.

Further, according to the above aspect, the time includes a chronometric time and the accumulated time of the accumulated dose.

Furthermore, according to the above aspect, the display unit is a liquid crystal display, and the data displayed on the display unit includes the detected intensity of the UV ray and the accumulated time and dose.

Additionally, according to another aspect, the carry-on chronometric device having UV detection and warning functions further comprises a carry-on device for carrying the carry-on chronometric device, in that the carry-on device including a watch chain, a necklace, and the like.

### BRIEF DESCRIPTION OF DRAWINGS

Other features and advantages of the present invention will become more apparent from the detailed description in conjunction with the following drawings:

FIG. 1 is a block diagram, showing a schematic structure of a preferred embodiment in accordance with the present invention;

FIG. 2 is a perspective view, illustrating a product of the preferred embodiment of the present invention; and

FIG. 3 is a flow chart, illustrating operation procedures of the preferred embodiment of the present invention.

### DETAILED DESCRIPTION OF THE INVENTION

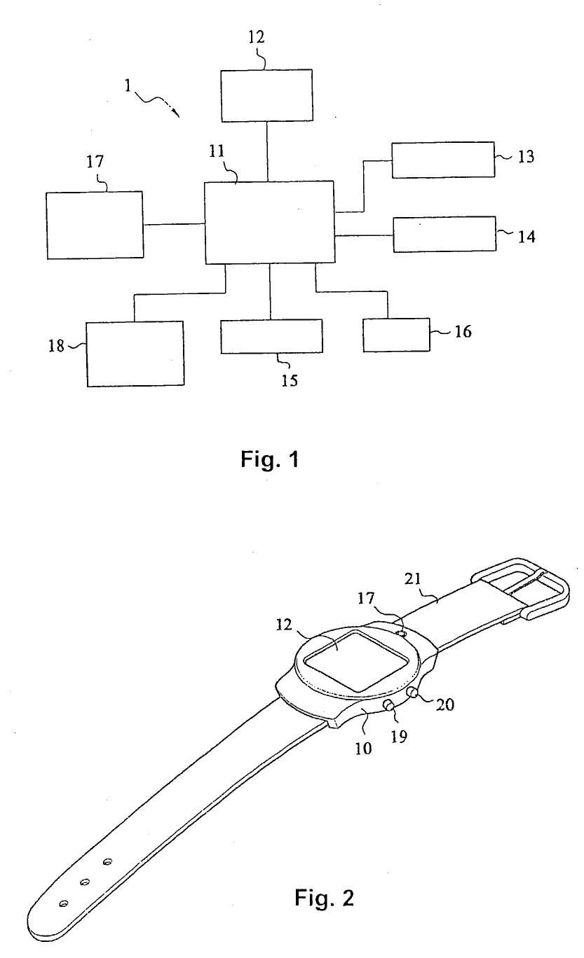

Referring to FIGS. 1 and 2, FIG. 1 shows a structure of a preferred embodiment of a carry-on chronometric device having UV detection and warning functions according to the invention, and FIG. 2 shows its product. The carry-on chronometric device 1 includes a housing 10. The housing 19 contains a control circuit unit 11, a display unit 12, a memory unit 13, an input unit 14, a chronometric unit 15, a battery 16, an UV detector unit 17 and a time-varying intensity accumulator 18.

As shown in FIGS. 1 and 2, the control circuit unit 11 is used for processing the data and the chronometric time and for controlling the action of each member of the device based on internal self-generated and external control signals. The memory unit 13 is used for storing the data. The unit 14 is used to input a control signal to the control circuit unit 11 by an user through an external control button 20, such that the control circuit unit 11 may process the data and the chronometric time and control the action of each member of the device based on a selection mode determined by a selection button 19.

The display unit 12, such as a liquid crystal display, is used for display of the time and data, wherein the display of the data is controlled by the selection button 19 through the control circuit unit 11. The chronometric unit 15 has the function of an ordinary digital watch which can provide a chronometric time and an accumulated time that is similar to a timer. The chronometric time and the accumulated time can be displayed on the display unit 12 through the control of the control circuit unit 11 that is selected by the selection button 19. The battery 16 can provide a working voltage to each member for execution of each corresponding function.

According to the invention, the carry-on chronometric device 1 also includes an UV ray detector unit 17. The UV ray detector unit 17 is used for detecting ambient UV intensity, the data of which can be displayed on the display unit 12 through the control of the control circuit unit 11 that is controlled by the control button 20. The intensity of the UV ray can be calculated in the UV ray detector unit 17 and converted to an UV index and data of harmful tolerance of the exposure including the maximum exposure time, which can also be displayed on the display unit 12. The carry-on chronometric device 1 further includes a time-varying intensity accumulator 18. Te time-varying intensity accumulator 18 receives the data of UV ray intensity from the UV ray detector unit 17 and time from the chronometric unit 15, and accumulates the UV ray intensity and time to obtain the accumulated dose of the UV ray intensity and the accumulated time which can also be displayed on the display unit 12 through the selection mode. Thus, the data displayed on the display unit 12 includes the detected UV intensity and the accumulated time and dose other than the chronometric time.

Additionally, the carry-on chronometric device 1 further includes a carry-on device 21 which is used for carrying the carry-on chronometric device 1. The carry-on device 21 can be a device such as a watch chain, a necklace, or the like. The carry-on device 21 shown in FIG. 2 is an exemplary watch chain.

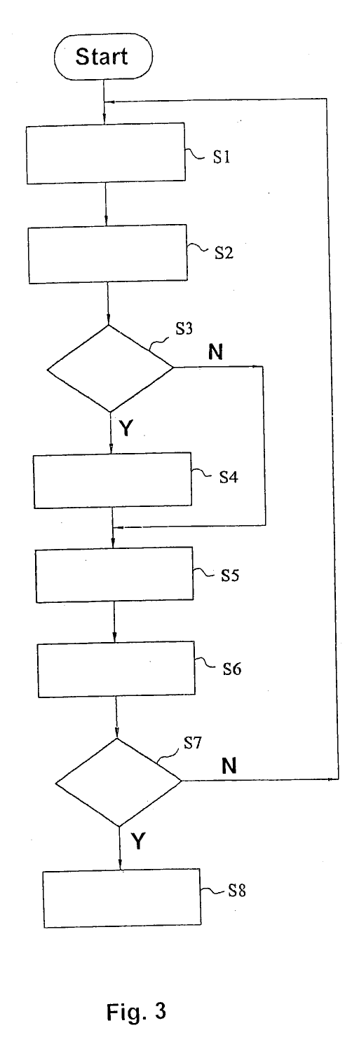

Referring to FIG. 3, FIG. 3 shows a flow chart for operation procedures of the preferred embodiment, wherein the operation procedures only include the procedures of the UV detector portion and warning portion of the invention, because the operation of the chronometric portion is the ordinary chronometric mode of a digital watch which is omitted here. Initially, in step S1, the UV detection mode is selected by the selection button 19. The ambient UV intensity is detected by the UV detector unit 17. Then, in Step S2, the UV detector unit 17 calculates the detected UV intensity according to preset parameters and obtains the data of the UV index and harmful tolerance of the exposure. These data are displayed on the display unit 12 for user's reference. in step S3, the UV detector unit 17 judges whether the UV index is larger than or equivalent to 6 or not. If it is larger than or equivalent to 6, then a beeper (not shown) is turned on and alarms to indicate that the UV intensity is too large which is possibly harmful to the user. Then, the procedure goes to step S5. If it is not larger than or equivalent to 6, the procedure directly goes to step S5. In Step S5, the time-varying intensity accumulator unit 18 is used for calculation of the UV intensity into the UV dose and of the time into the accumulated time. Then, in step S6, the UV dose and the accumulated time are displayed on the display unit 12 for user's reference. In step S7, the time-varying intensity accumulator unit 18 judges whether the UV dose or the accumulated time is larger than a preset value. If it is larger than a preset value, then the beeper alarms to indicate that the accumulated time or the UV dose is in excess and is possible to be harmful to the user. If it is not larger than the preset value, then the procedure goes back to the step S1 and continues the procedure for detection of the ambient UV intensity. When the beeper is activated, the user may push a reset button (not shown) to stop the alarm and/or reset the detected value.

Above described are preferred embodiments of the present invention which are not intended to limit the present invention, Simply equivalent change and modification without departing from the claim must be considered as falling within the spirit and scope of this invention.

### List of Reference Numerals

1 carry-on chronometric device

10 housing

11 control circuit unit

12 display unit

13 memory unit

14 input unit

15 chronometric unit

16 battery

17 UV detector unit

18 time-varying intensity accumulator

19 selection button

20 control button

21 carry-on device

What is claimed is:

1. A carry-on chronometric device, for detection of UV ray and display of time and data, said device comprising:
a housing, for defining a containing space, which contains:
a control circuit unit, for processing the time and the data, and controlling action of each member of the device, based on a control signal;
a display unit, for displaying the time and the data;
a memory unit, for storing the data;
an input unit, for input of the control signal to the control circuit unit to process the data and control the action of each member of the device based on the control signal;
a chronometric unit, for providing the time;
a battery, for providing a working voltage to each member;
an UV detector unit, for detecting an intensity of the UV ray; and
a time-varying intensity accumulator, for accumulating the intensity of the UV ray and calculating an accumulated dose of the intensity, and for output of the intensity and the accumulated dose to the display unit for displaying and to the memory unit for storage.

2. The carry-on chronometric device according to claim 1, wherein the time includes a chronometric time, and an accumulated time for the accumulated dose.

3. The carry-on chronometric device according to claim 1, wherein the display unit is a liquid crystal display, and the data displayed on the display unit includes the detected intensity of the UV ray and the accumulated time and dose.

4. The carry-on chronometric device according to claim 1, further comprising a carry-on device, for carrying the carry-on chronometric device, the carry-on device including a watch chain, a necklace, and the like.
